(19) United States
(12) Patent Application Publication
(10) Pub. No.: US 2004/0229484 A1
(43) Pub. Date: Nov. 18, 2004

(54) Receptacle

(76) Inventor: Shinji Uchida, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/784,304

(22) Filed: Feb. 24, 2004

(30) Foreign Application Priority Data
Feb. 25, 2003 (JP) 2003-048127

(51) Int. Cl. H01R 13/44

(52) U.S. Cl. 439/137

(57) ABSTRACT

A miniature receptacle having female contacts of the type which are not uncovered when a mating plug is not inserted is provided. A insulative socket housing(1) has an opening part(11) into which a plug having male contacts of the dual in-line type is inserted. A polarity of female contact (2) are arrayed in parallel on a pair of inner walls forming the opening part(11) to be opposed each other across the opening part(1). A shutter (3) is disposed within the opening part(11). The shutter shields a front face of the opening part(11) when the plug is removed and retracts towards a rear face of the opening part when the plug is inserted. A pair of compressed coil springs (5) are provided within the opening part(11) and give force to move the shutter(3).

### CROSS-REFERENCE TO RELATED APPLICATIONS

This application is based upon and claims the benefit of priority from the prior Japanese Patent Application No.2003-048127 filed on Feb. 25th in 2003, the entire contents of which is incorporated herein by reference.

### FIELD OF THE INVENTION

The present invention relates to a receptacle (or a receptacle connector) for electric connection.

### BACKGROUND OF THE INVENTION

Recently, miniature electronic devices such as cellular phones, micro video cameras, and portable information terminals can send and receive data to and from desk top personal computers. These miniature electronic devices are mounted with a receptacle which is used as an interface connector (or an I/O connector) for sending or receiving data.

In many cases, electronic devices with the receptacle use a connection base designated as a cradle (also referred to as a docking station) for sending or receiving data.

The cradle is mounted with a plug thereon and is connected to a cable by which the cradle and a desk top personal computer ate connected to each other. On the other hand, an electronic device such as portable information terminals has a receptacle, and the receptacle disposed on the electronic device can be connected to the plug mounted on the cradle to secure high speed data transfer between the electronic device and the desk top personal computer. One of the simplest forms of the cradle is a charger for cellular phones.

Additionally, when the receptacle disposed on the electronic device and the plug mounted on the cradle are not connected to each other, contacts provided within the receptacle is exposed unprotected. As a result, the contacts maybe damaged by handling or dust.

To solve this problem, a receptacle having a cap or a cover for covering the receptacle so as to protect contacts arrayed in the receptacle from dust or handling has known.

Another dustproof connector by providing a shutter, instead of a cap or a cover for covering the receptacle has been provided (Japanese Unexamined Patent Publication No. 2001-351747). The connector disclosed in the Patent Document comprises a receptacle comprising a shutter which is closed to cover contacts disposed within the receptacle when a plug is not inserted into the receptacle. Thus, when a plug is not inserted into the receptacle, the contacts are protected from dust, whereas when a plug is inserted, the shutter is opened by pushing back the plug, thereby enabling the plug and the receptacle to come into contact with each other.

However, the cap or the cover should be removed from the receptacle having the cap or the cover, every time a plug is connected to the receptacle, making the connection more troublesome. Furthermore, there is a fear that the cap or the cover may be lost.

The plug mounted on a cradle is generally a multi-polar dual in-line plug having two rows of contacts. In the dual in-line plug, the contacts arrayed in two lines are surrounded by insulative fixed vertical walls protecting the contacts from being handled. Such a dual in-line plug is called four-wall shrouded, thereby having a large outer size.

However, electronic devices (micro video cameras, for example) to be connected to a cradle equipped with a dual in-line plug are increasingly being reduced in size. For this reason, it has been sought to miniaturize a dual in-line receptacle which can be connected to a dual in-line plug and can be attached to the aforementioned electronic devices.

However, the shutter provided within the receptacle of the dustproof multi-conductor connector disclosed in the aforementioned Patent Document is a folding retractable shutter composed of a plurality of shutter components, and the multi-conductor connector also has a locking mechanism. These features inevitably increase the outer size, making the receptacle unsuitable as a micro receptacle for use in an interface, which is now being sought.

In order to solve the aforementioned problems, the present invention has an object of providing a miniature multi-polar receptacle which can prevent contacts thereof from being exposed unprotected all the time.

### SUMMARY OF THE INVENTION

In order to accomplish the object, the inventors of the present invention have invented the following new receptacle.

(1) A receptacle comprising: an insulative socket housing having an opening part through which a plug having dual in-line male contacts is inserted; female contacts which are arrayed in parallel on a pair of inner walls opposed to each other of the opening part and come into contact with the male contacts when the plug is inserted into the opening part; and an insulative shutter which closes a front face of the opening part when the plug is removed and retracts towards a rear face of the opening part by being pushed by the plug when the plug is inserted

According to the invention described in (1), when the receptacle is not connected to a plug, the shutter closes the opening part of the receptacle, thereby protecting the female contacts from dust. On the other hand, when a plug is inserted into the receptacle, the shutter is retracted by being pushed back by the plug, making the male contacts of the plug come into contact with the female contacts of the receptacle.

(2) The receptacle according to(1), wherein the shutter is provided with an elastic member for moving the shutter towards the front face of the opening part when the plug is removed from the opening part.

According to the invention described in (2), when the plug inserted in the receptacle is removed, the force caused by the elastic member makes the shutter to close the front face of the opening part through which to insert the plug, thereby shutting off the contacts from outside. As a result, the female contacts can be protected from dust or handling. The aforementioned elastic member can be a compressed coil spring, for example.

(3) The receptacle according to (1) or (2), wherein legs of the female contacts is extended from the socket housing to be fixed on a printed circuit board

According to the invention described in (3), the legs of each of the female contacts are welded by soldering or the like to the positioning pattern formed on the printed-circuit board, so as to mount the receptacle on the surface of the board.

(4) The receptacle according to anyone of (1) to (3) further comprising: a shell for covering the socket housing; and a pair of soldering tabs for fixing the socket housing onto the printed-circuit board disposed on side parts of the shell

According to the invention described in (4), the shell covering the socket housing can be fixed on the printed-circuit board by soldering to reinforce retention against the force caused by pulling out a plug.

(5) The receptacle of according to any one of (1) to (3) further comprising: a shell for covering the socket housing, and the shell is formed of a metal thin plate and comprises a member for partially covering the front face of the opening part.

(6) The receptacle of according to (3): wherein the shell is formed of a metal thin plate and comprises a member for partially covering the front face of the opening part.

According to the invention described in (5) and (6), the shell formed of a metal thin plate covering the socket housing reinforces the socket housing structurally, and at the same time, shields the receptacle. The shell partially covers an inserting face (the front face) of the opening part formed in the receptacle through which a plug is inserted. Therefore, in the case where a mating plug having a plug shell covering a header part of the plug is used, when the mating plug is inserted into the receptacle, the plug shell and the shell of the receptacle come into partial contact each other, thereby making the plug and the receptacle integrally shielded.

(7) The receptacle according to any one of (1) to (6) to be used as an interface connector of a miniature electronic device

(8) The receptacle according to any one of (1) to (7), wherein the female contacts are arrayed in parallel at regular intervals of 0.5 mm.

(9) A method for connecting a plug to the receptacle according to any one of claims 1 to 8, the plug comprising: an insulative plug housing having a frame part and a header part which is formed integrally with the frame part and is protruded from the frame part to be inserted into the receptacle; male contacts arrayed in parallel and pairs on the header part; and a plug shutter which covers the male contacts arrayed on the header part and can be stored in the frame part, and the method comprising: moving the plug shutter towards the rear face of the opening part along inner walls of the opening part when the plug is inserted into the opening part of the receptacle; and moving the plug shutter towards the front face of the opening part along the inner walls of the opening part when the plug is removed from the receptacle.

According to the invention described in (9), in the process of inserting the plug into the receptacle, the shutters are pushed backward to the opposite direction of inserting direction and make the male and female contacts exposed and come into contact with each other. In the process of removing the plug from the receptacle, the shutters move forward to the inserting face (front face) so as to cover the contacts, thereby protecting the contacts from dust, handling, or the like. Thus, unless the shutter of the receptacle or the plug shutter is intentionally pushed down, the female and male contacts are covered by the shutter or the plug shutter, respectively for protection.

(10) A plug capable of being connected to the receptacle according to any one of claims 1 to 8

The “insulative socket housing” can be assumed to be a socket housing made from a material electrically isolated, and to have a function of holding and protecting the female contacts with an electrically insulating member.

The “insulative socket housing” can be integrally molded with an electrically insulative synthetic resin member. After the socket housing is molded integrally using a synthetic resin member, the socket housing can be processed mechanically in parts. Furthermore, the socket housing can be made by cutting process.

The “female contacts” of the present invention can be so-called blade contacts having a rectangular horizontal cross section and no spring properties, and when the female contacts formed to have a width of 0.3 mm or so, the female contacts can be arrayed at a pitch of about 0.5 mm.

The number of poles of the female contacts to be arrayed is preferably 40 or more when the receptacle is used as an interface connector. In other words, as many as 20 female contacts can be arrayed in parallel on one side, and 13 female contacts can be arrayed in parallel on one side making 26 poles as a pair lines depending on the application of the receptacle connector.

The “insulative shutter” can be assumed to be a shutter made from a material electrically isolated, and not shorting when it contacts with the female contacts. The shutter can be assumed to cover the front face of the opening part so as to protect the female contacts from dust, except for the state where the receptacle is connected to a mating plug.

The shutter can be assumed to be moved towards the side of the front face of the opening part by a power caused by a pair of elastic members (compressed coil springs, for example) disposed at both flanks of a back face of the shutter. The shutter can be assumed to be slid into the opening part towards the rear face by being pushed by the inserted plug when the plug is inserted into the opening part.

The shell made of a metal thin plate having a thickness of about 0.2 mm reinforces the receptacle structurally by covering the insulative socket housing, and further fizxing firmly the receptacle by being soldered to the printed-circuit board.

The receptacle with such a simple structure can be lowered in height, making it possible to be mounted on a miniature electronic device, thereby successfully miniaturizing a mating plug.

### BRIEF DESCRIPTION OF THE DRAWINGS

FIG. 1 is a disassembled perspective view of a receptacle of an embodiment of the present invention.

FIG. 2A is a plan view of the receptacle when assembled.

FIG. 2B is a front view of the receptacle when assembled.

FIG. 2C is a side view of the receptacle when assembled.

FIG. 2D is a cross sectional view of the receptacle taken along the line X-X of FIG. 2B.

FIG. 3A is a cross sectional view of the receptacle taken along the line Y-Y of FIG. 2D.

FIG. 3B is a cross sectional view of the receptacle taken along the line Z-Z of FIG. 2A.

FIG. 4 is a pattern layout formed on a printed-circuit board on which the receptacle to be mounted.

FIG. 5 is an external perspective view of the assembled receptacle, with the shutter covering the opening part.

FIG. 6 is an external perspective view of the assembled receptacle, with the shutter open.

FIG. 7 is an external perspective view of a plug of an embodiment to be connected to the receptacle.

FIG. 8 is the plug shutter of the plug of FIG. 8 when buried in the frame part.

FIG. 9 is a view showing the receptacle and the plug opposed to each other.

FIG. 10 is a cross sectional view showing the state where the header part of the plug is inserted into the opening part of the receptacle.

### DETAILED DESCRIPTION OF THE PREFERRED EMBODIMENT

The embodiments of the present invention will be explained as follows based on the drawings.

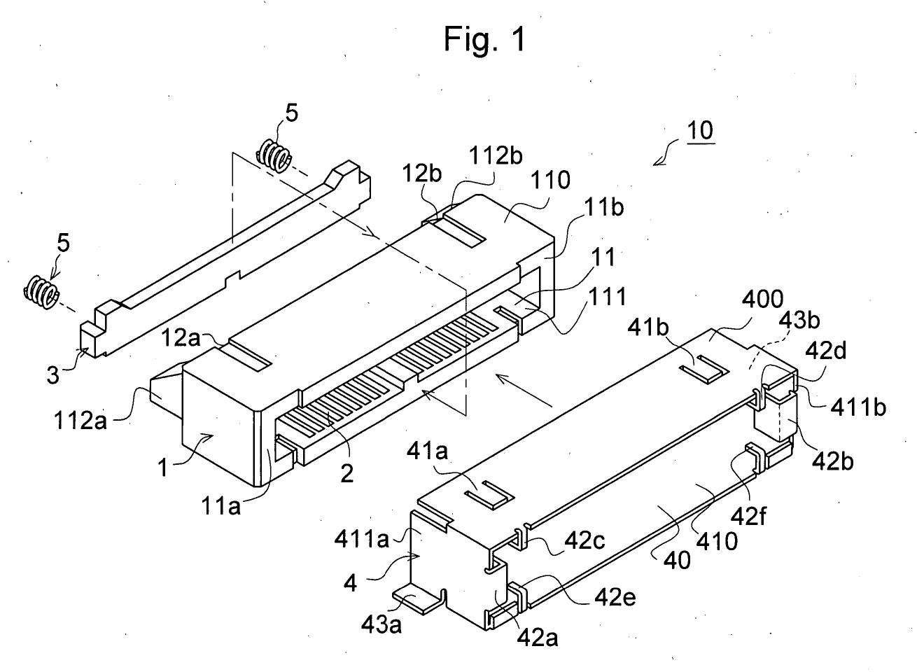

FIG. 1 is a disassembled perspective view'showing the structure of a receptacle in an embodiment of the present invention. In the- embodiment shown in FIG. 1, the receptacle 10 includes a socket housing 1, female contacts 2, a shutter 3, a shell 4, and compressed coil springs 5.

In the embodiment of FIG. 1, the insulative socket housing 1 includes an upper wall 110, a lower wall 111, and vertical frames 11a and 11b. The upper wall 110 and the face wall 111 are toward each other, and the vertical frame 11a and the vertical frame 11b are toward each other respectively, and there is an opening part 11 surrounded by the vertical frames 11a and 11b, the upper wall 110, and the lower wall 111. In other words, inner walls of the opening part 11 contain the vertical frames 11a and 11b, the upper face wall 110, and the lower face wall 111. And the female contacts 2 are arrayed in parallel on a pair of opposed inner walls of the opening part 11 making a pair of paralleled rows of the female contacts 2. To be more specific, the female contacts 2 are arranged in parallel on an inner side of the upper wall 10a and on an inner side of the lower wall 10b of the opening part 11.

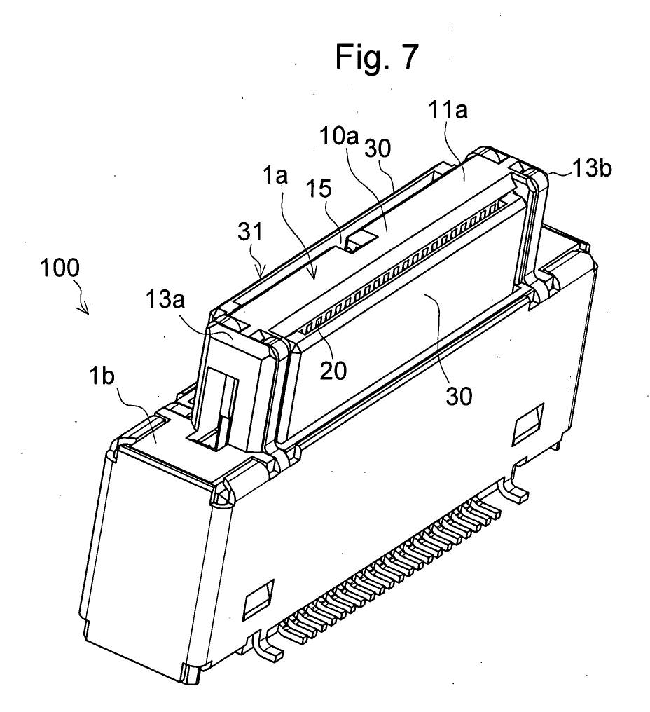

The socket housing 1 is equipped with a pair of back walls 112a and 112b on a face (rear face) which is opposed to a face (front face) toward which a mating plug 100 (refer to FIG. 7) is inserted. The plug 100 is inserted into the opening part 11 of the socket housing 1 from the front face side. The opening part 11 keeps the shutter 3 inside via the compressed coil springs 5 which are the elastic members.

The socket housing 1 is laid in such a manner that the lower wall 111 is attached to a printed-circuit board, and the upper wall 110 is intended to be an upper side when the receptacle 10 is welded to the printed-circuit board. The upper wall 110 has a pair of latch grooves 12a and 12b. The latch grooves 12a and 12b lock latches 41a and 41b of the shell 4, which will be described later.

The shell 4 is formed by folding a thin metal plate in such a manner as to be a rectangular tube having a shell opening part 40 inside. The shell 4 includes an upper face wall 400 and a lower face wall 410 opposed to each other, and an outer wall 411a and 411b opposed to each other. The upper face wall 400 covers the upper wall 110 of the socket housing 1; the lower face wall 410 covers the lower wall 111; the outer wall 411a covers the vertical frame 11a; and the outer wall 411b covers the vertical frame 11b respectively.

The shell opening part 40 has a size sufficient to cover the socket housing 1, and the receptacle 10 is assembled so that the socket housing 1 is inserted within the shell opening 40 of the shell 4 from the front face side of the opening part 11. The upper-face wall 400 of the shell 4 includes the pair latches 41a and 41b each formed by being cut out in the form of the letter U. The latches 41a and 41b are slightly bent inward.

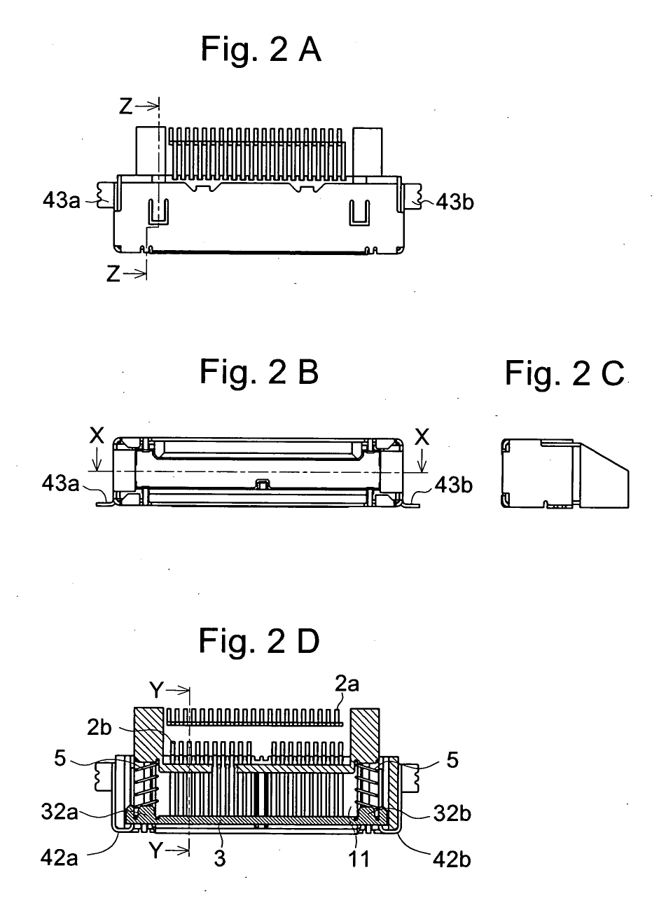

On the front face of the shell 4 through which to insert the plug 100 are provided a pair of bezels 42a and 42b protruding from the outer walls 411a and 411b toward the shell opening part 40. The bezels 42a and 42b extend parallel to the front face of the shell opening part 40 from the outer walls 411a and 411b of the shell 4, and are bent towards the rear face opposed to the front face. The bezels 42a and 42b each have a L-shaped horizontal cross section (cross section taken along the line X-X of FIG. 2B) which is parallel to the upper face 400. The bezels 42a and 42b are assembled so as to be engaged with the vertical frames 11a and 11b, respectively, of the socket housing 1.

The upper face wall 400 of the shell 4 is provided with a pair of contact pieces 42c and 42d protruding towards the shell opening part 40. The contact pieces 42c and 42d extend parallel to the front face of the shell opening part 40 and further extend towards the rear face of the shell opening part 40. Similarly, the lower face wall 410 of the shell 4 is provided with a pair of contact pieces 42e and 42f protruding towards the shell opening part 40.

When the socket housing 1 and the shell 4 are combined, the contact pieces 42c and 42d lock the upper wall 110 of the socket housing 1, whereas the contact pieces 42e and 42f lock the lower wall 111 of the socket housing 1.

In addition, a tab 43a and a tab 43b are provided at the bottom parts of the opposed outer walls 411a and 411b protruding from the shell 4. The tabs 43a and 43b are solderable and fixed on the printed-circuit board. The tab 43b is not illustrated in FIG. 1.

The structure of the receptacle 10 in the present embodiment will be further explained as follows. FIG. 2A is a plan view of the receptacle 10 when assembled, FIG. 2B is the front view thereof, FIG. 2C is a side view thereof, and FIG. 2D is a cross sectional view taken along the line X-X of FIG. 2B.

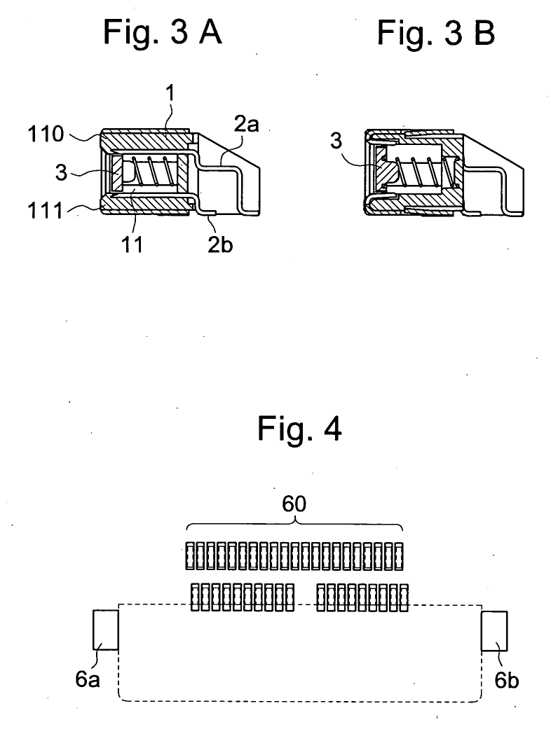

FIG. 3A is a cross sectional view taken along the line Y-Y of FIG. 2D, and FIG. 3B is a cross sectional view taken along the line Z-Z of FIG. 2A.

As shown in FIG. 3A, the socket housing 1 has two kinds of female contacts; long contacts 2a are disposed on the upper wall 110 and short contacts 2b are disposed on the lower wall 111. The long contacts 2a and the short contacts 2b are opposed to each other with the opening part 11 therebetween. The long contacts 2a and the short contacts 2b form a multi-polar dual in-line type which includes two rows of paralleled arrayed contacts as mentioned above.

A long contact 2a includes a flat part in contact with the upper wall 110 and a leg extending from the socket housing 1. The leg is bent at right angles at two stages, so that a final end is bent to be parallel to the flat part and can be seated on a printed-circuitboard (not illustrated in the Figs.) Similarly, a short contact 2b includes a flat part in contact with the lower wall 111 and a leg extending from the socket housing 1. The leg is bent in the direction orthogonal to the flat part, so that a final end is bent to be parallel to the flat part and can be seated on the unillustrated printed-circuit board.

The difference between the long contacts 2a and the short contacts 2b in this embodiment is the length of the extension from the socket housing 1 and the shape. The long contacts 2a are disposed to be the upper, and the short contacts 2b are disposed to be the lower in the receptacle 10. Since the present invention arranges the female contacts 2 at a small pitch of 0.5 mm or so, the female contacts 2 will be seated onto the surface of a printed-circuit board.

Next, the shutter 3 will be explained as follows. As shown in FIG. 2D, the insulative shutter 3 is held in the opening part 11 in a state of being movable within the opening part 11. The opening part 11 contains the pair compressed coil springs 5 which are elastic members. One end of each of the compressed coil springs 5 is locked to a pair of projections 32a or 32b provided on the shutter 3, whereas the other end of each of the compressed coil springs 5 is locked to the back wall 112a or 112b of the opening part.

By the aforementioned structure, the pair of compressed coil springs 5 gives a force to move the shutter 3 towards the front face of the opening part 11. In other words, the compressed coil springs 5 push the shutter 3 towards the front face of the opening part 11 when the plug 100 is not inserted, so the opening part 11 is shielded by the shutter 3. When the plug 100 is not inserted, an overrun of the shutter 3 is blocked by the pair of bezels 42a and 42b, making the shutter 3 to stay within the socket housing 1.

The pair of bezels 42a and 42b prevent the vertical frames 11a and 11b from being worn out or damaged by the insertion of a plug.

In the aforementioned receptacle 10, the female contacts 2 are welded to the printed-circuit board, and the shell 4 covering the receptacle 10 is also fixed on the printed-circuit board. FIG. 4 is a pattern layout of the positioning pattern formed on a surface of the printed-circuit board on which the receptacle 10 is mounted.

As shown in FIG. 4, the printed-circuit board includes positioning patterns 6a and 6b to which the tabs 43a and 43b of the shell 4 are soldered, and a positioning pattern group 60 to which the legs of the female contacts 2 are soldered. The female contacts 2 are fixed on the positioning pattern group 60 and soldered, like a surface mounting device, to the printed-circuit board with which the receptacle 10 is intended to be mounted.

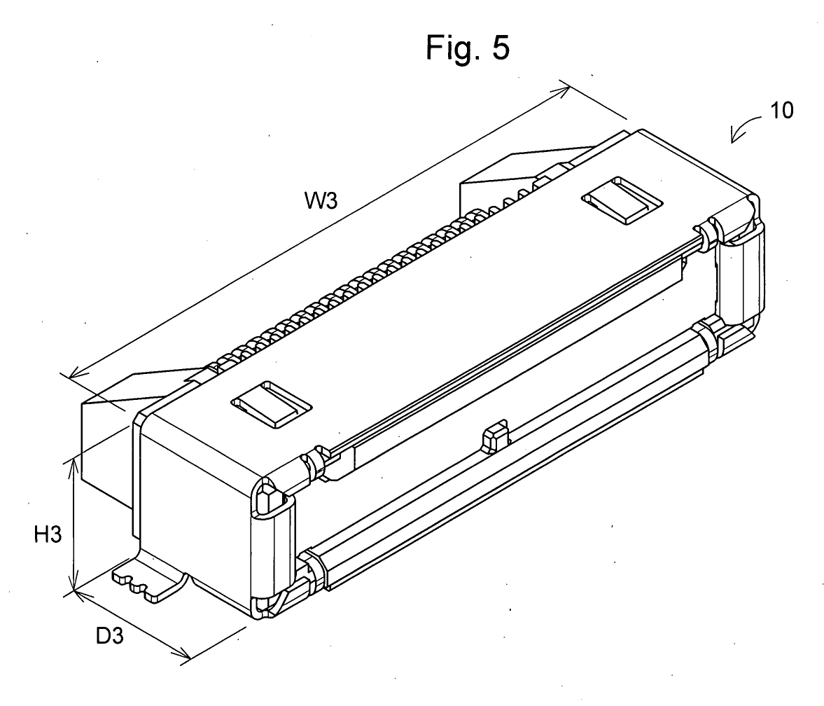

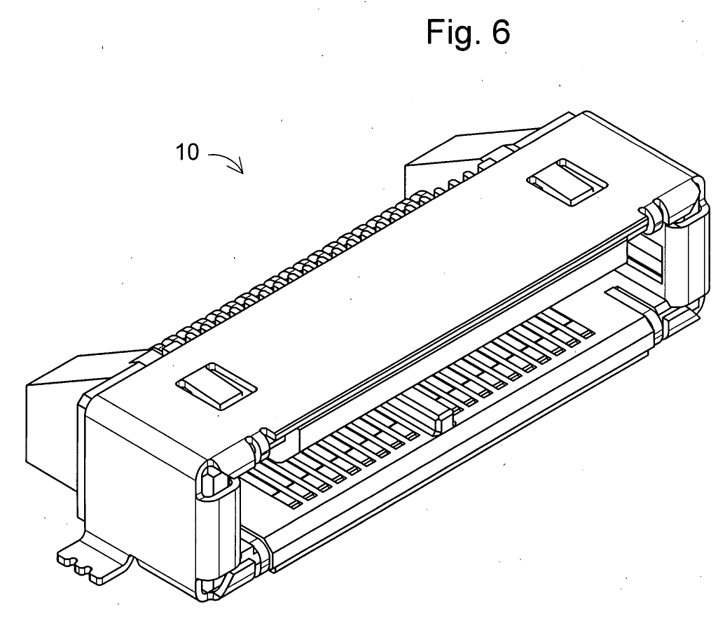

The following is a description of the effects of the present invention. FIG. 5 is an external appearance of the receptacle 10, showing the state where the shutter 3 shields the front face of the opening part 11. FIG. 6 is another external appearance of the receptacle 10, showing the state where the opening part 11 is not shielded by the shutter 3.

FIG. 7 is an external perspective view of the plug 100 of an embodiment which is connected to the receptacle 10 of FIG. 1. In FIG. 7, the plug 100 is provided with an insulative plug housing 10a and plural male contacts 20. The plug housing 10a includes a frame part 1b, and a header part 1a protruding from the frame part 1b. The header part 1a is formed integrally with the frame part 1b and provided with a plug shutter part 31 composed of a pair of insulative plug shutters 30 covering the male contacts 20.

The frame part 1b contains unillustrated compressed coil springs, and the compressed coil springs give force to raise the plug shutters 30 in the direction where the plug 100 is inserted into the receptacle 10 (upwards in FIG. 7). By this structure, as shown in FIG. 7, the plug shutter part 31 covers the male contacts 20, when the plug 110 is not inserted into the receptacle 10. On the other hand, when the plug 100 is inserted into the receptacle 10, the compressed coil springs contract to house the plug shutters 30 within the frame part 1b, making the male contacts 20 come into contact with the female contacts 2.

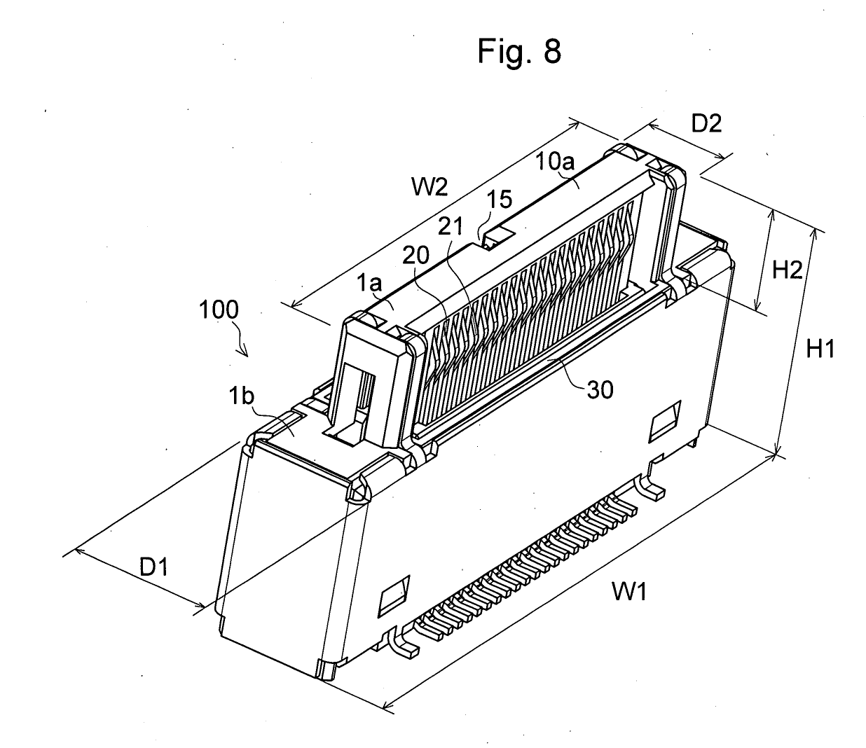

FIG. 8 shows the state where the plug shutters 30 are retracted and stored in the frame part 1b. In FIG. 8, the male contacts 20 are arrayed on the header part 1a in the form of a dual in-line type. A male contact 20 is a flexible leaf spring having flexible top part 21.

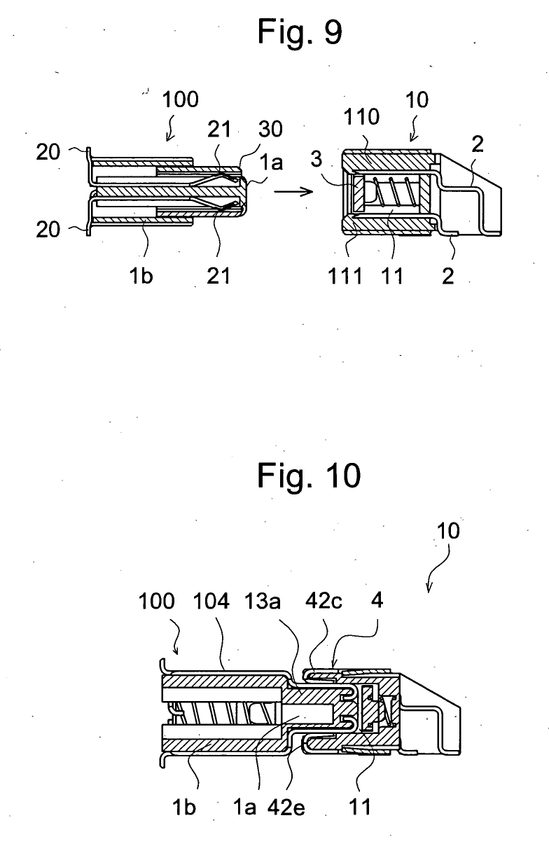

FIG. 9 is a cross sectional view showing the case where the receptacle 10 and the plug 100 are disposed opposed to each other. In FIG. 9, when the plug 100 is not inserted into the receptacle 10, the shutter 3 closes the frontface of the opening part 11 in the receptacle 10. On the other hand, in the plug 100, the plug shutters 30 cover the male contacts 20.

As shown in FIG. 9, the pair of male contacts 20 opposed to each other across a plate is held within the header part 1a in such a manner where the flexible top parts 21 of their flexible leaf springs are protruded towards opposite directions to each other.

When the header part 1a of the plug 100 is inserted into the opening part 11 of the receptacle 10 from the state of FIG. 9, the plug shutters 30 retract so as to be stored in the frame part 1b along the upper wall 110 and the lower wall 111 composing the opening part 11. On the other hand, the shutter 3 of the receptacle 10 is pushed by the header part 1a and retracted towards the rear face of the opening part 11.

When the header part 1a of the plug 100 is completely inserted into the opening part 11 of the receptacle 10, the female contacts 2 are exposed as shown in FIG. 6 in the receptacle 10. On the other hand, as shown in FIG. 8, in the plug 100 the male contacts 20 are exposed and set to come into contact with the female contacts 2.

FIG. 10 is a cross sectional view in which the header part la of the plug 100 is inserted into the opening part 11 of the receptacle 10. FIG. 10 is the cross sectional view taken along the line Z-Z of FIG. 2A like FIG. 3B, and the plug 100 is cross sectioned along a vertical support 13a of FIG. 7.

In FIG. 10, the frame part 1b of the plug housing 10a is covered with the metal plug shell 104 which is not illustrated in FIG. 7 nor FIG. 8. The plug shell 104 also partially covers the vertical supports 13a and 13b.

In FIG. 10, the plug shell 104 is in contact with the contact pieces 42c and 42e of the receptacle 10. Although it is not illustrated, the plug shell 104 is also in contact with the contact pieces 42d and 42f of the receptacle 10.

Thus, in the shell 4 of the receptacle 10, the contact pieces 42c to 42f partially cover the front face of the opening part 11. The header part 1a, the vertical supports 13a and 13b of the plug 100 on the other end are partially covered with the plug shell 104 made of a metal plate. When the plug 100 is inserted into the receptacle 10, the plug shell 104 and the shell 4 of the receptacle 10 partly contact each other, which makes the plug 100 and the receptacle 10 be shielded integrally.

In the embodiment shown in FIG. 8, the plug 100 has a lateral width W1 of 19.6 mm, a depth D1 of 4.1 mm, and a height H1 of 9.5 mm. The protruding header part 1a of the plug 100 has a lateral width W2 of 14.7 mm, a depth D2 of 2.4 mm, and a height H2 of 3.2 mm. The male contacts 20 have a pitch of 0.5 mm and 42 poles; however, two poles become unusable (not contactable) because of a key groove 15, so the substantial number of poles is 40.

On the other hand, in the embodiment shown in FIG. 5, the receptacle 10 has a lateral width W3 of 17.4 mm, a depth D3 of 4.7 mm, and a height H3 of 4.1 mm. The female contacts 2 (See FIG. 1) have a pitch of 0.5 mm and 42 poles; however, two poles become unusable (not contactable) because of a key, so the substantial number of poles is 40. Thus, the receptacle small in size and with multi poles is suitable as the interface connector for use in miniature electronic devices.

The receptacle of the present invention can protect the female contacts from dust because the front face of the opening part holding the female contacts inside is shielded by the shutter when the receptacle is not connected to a mating plug.

When the mating plug is connected to the receptacle, the shutter is pushed by the plug, making the male contacts of the plug come into contact with the female contacts of the receptacle.

Covering the male contacts of the dual in-line type from both sides and using a plug having a reciprocating thin plate shutter in combination with the receptacle of the present invention can provide dust-proof measures for both the plug and the receptacle.

What is claimed is:

1. A receptacle comprising:
an insulative socket housing having an opening part through which a plug having dual in-line male contacts is inserted;
female contacts which are arrayed in parallel on a pair of inner walls opposed to each other of the opening part and come into contact with the male contacts when the plug is inserted into the opening part; and
an insulative shutter which closes a front face of the opening part when the plug is removed and retracts towards a rear face of the opening part by being pushed by the plug when the plug is inserted.

2. The receptacle according to claim 1, wherein the shutter is provided with an elastic member for moving the shutter towards the front face of the opening part when the plug is removed from the opening part.

3. The receptacle according to claim 1, wherein legs of the female contacts is extended from the socket housing to be fixed on a printed circuit board.

4. The receptacle according to claim 2, wherein legs of the female contacts is extended from the socket housing to be fixed on a printed circuit board.

5. The receptacle according to any one of claims 1 to 4 further comprising:
a shell for covering the socket housing; and
a pair of soldering tabs for fixing the socket housing onto the printed-circuit board disposed on side parts of the shell.

6. The receptacle of according to any one of claims 1 to 4 further comprising:
a shell for covering the socket housing, and the shell is formed of a metal thin plate and comprises a member for partially covering the front face of the opening part.

7. The receptacle of according to claim 5: wherein the shell is formed of a metal thin plate and comprises a member for partially covering the front face of the opening part.

8. The receptacle of according to any one of claims 1 to 4 to be used as an interface connector of a miniature electronic device.

9. The receptacle according to any one of claims 1 to 4, wherein the female contacts are arrayed in parallel at regular intervals of 0.5 mm.

10. A method for connecting a plug to the receptacle according to any one of claims 1 to 4, the plug comprising:
an insulative plug housing having a frame part and a header part which is formed integrally with the frame part and is protruded from the frame part to be inserted into the receptacle;
male contacts arrayed in parallel and pairs on the header part; and
a plug shutter which covers the male contacts arrayed on the header part and can be stored in the frame part, and the method comprising:
moving the plug shutter towards the rear face of the opening part along inner walls of the opening part when the plug is inserted into the opening part of the receptacle; and
moving the plug shutter towards the front face of the opening part along the inner walls of the opening part when the plug is removed from the receptacle.

11. A plug capable of being connected to the receptacle according to any one of claims 1 to 4.
